(19) United States
(12) Patent Application Publication
(10) Pub. No.: US 2017/0004698 A1
(43) Pub. Date: Jan. 5, 2017

(54) INDICATING CIRCUIT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: JIN-SHAN MA, Shenzhen (CN); WU ZHOU, Shenzhen (CN)

(21) Appl. No.: 14/825,373

(22) Filed: Aug. 13, 2015

(30) Foreign Application Priority Data
Jul. 2, 2015 (CN) 201510380340.6

(51) Int. Cl. G08B 21/18

(52) U.S. Cl. CPC G08B 21/182

(57) ABSTRACT

An indicating circuit includes a first control module, a second control module, a third control module and an alarm module. When the electronic device is operating and the temperature of the electronic device exceeds a preset value, the first control module outputs a second control signal to the third control module, the second control module outputs the second control signal to the third control module, the third control module outputs the second control signal to the alarm module, and the alarm module indicates the temperature of the electronic device exceeds the preset value.

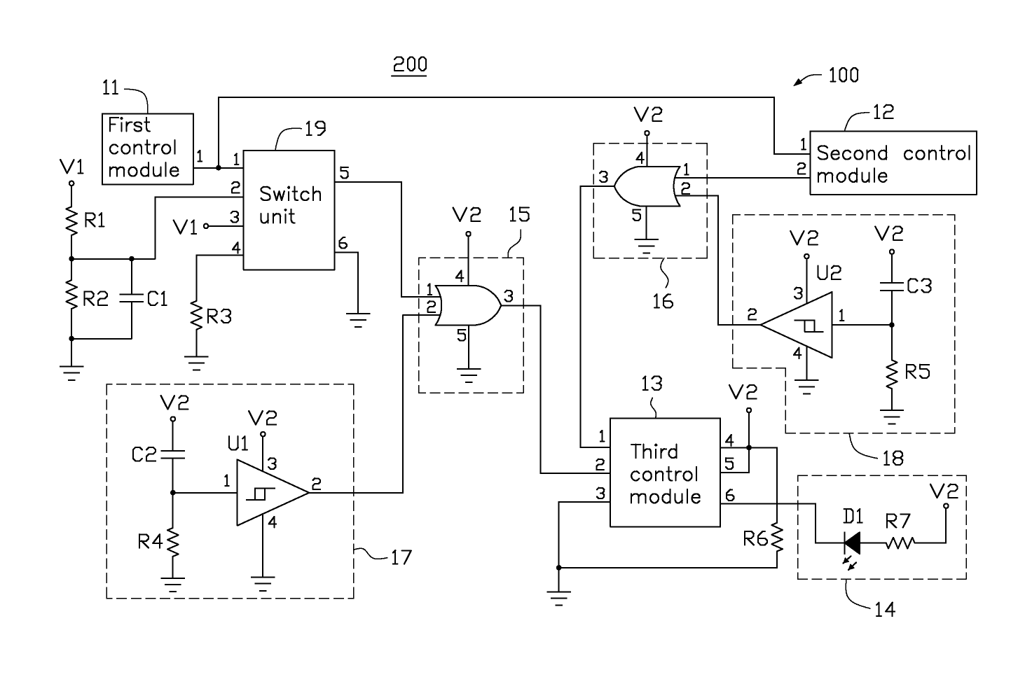

### FIELD

The subject matter herein generally relates to an indicating circuit.

### BACKGROUND

An indicating circuit can indicate problems.

### BRIEF DESCRIPTION OF THE DRAWINGS

Implementations of the present technology will now be described, by way of example only, with reference to the attached figures.

The FIGURE is a circuit diagram of an embodiment of an indicating circuit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to an electronic device with a power switch system.

The FIGURE shows an embodiment of an indicating circuit 100 comprising a first control module 11, a second control module 12, a third control module 13, an alarm module 14, a first logic unit 15, a second logic unit 16, a first delay module 17, a second delay module 18, and a switch unit 19.

A signal output pin 1 of the first control module 11 is coupled to a signal input pin 1 of the switch unit 19.

A power pin 2 of the switch unit 19 is coupled to a first power terminal V1 through a resistor R1. The power pin 2 of the switch unit 19 is grounded through a resistor R2. A capacitor C2 and the resistor R2 are coupled in parallel. A power pin 3 of the switch unit 19 is coupled to the first power terminal V1. A ground pin 4 of the switch unit 19 is grounded through a resistor R3. A signal output pin 5 of the switch unit 19 is coupled to a first input terminal 1 of the first logic unit 15. A ground pin 6 of the switch unit 19 is grounded.

The first delay module 17 can comprise a Schmitt filter U1. An input terminal 1 of the Schmitt filter U1 is grounded and is coupled to a second power terminal V2 through the capacitor C2. An output terminal 2 of the Schmitt filter U1 is coupled to a second input terminal 2 of the first logic unit 15. A power terminal 3 of the Schmitt filter is coupled to the second power terminal V2. A ground terminal 4 of the Schmitt filter is grounded.

An output terminal 3 of the first logic unit 15 is coupled to an enable pin 2 of the third control module 13. A power terminal 4 of the first logic unit 15 is coupled to the second power terminal V2. A ground terminal 5 of the first logic unit 15 is grounded.

A signal input pin 1 of the second control module 12 is coupled to the signal output pin 1 of the first control module 11. A signal output pin 2 of the second control module 12 is coupled to a first terminal 1 of the second logic unit 16.

The second delay module 18 can comprise a Schmitt filter U2. An input terminal 1 of the Schmitt filter U2 is grounded through a resistor R5. The input terminal 1 of the Schmitt filter U2 is coupled to the second power terminal V2 through a capacitor C3. An output terminal 2 of the Schmitt filter U2 is coupled to a second input 2 of the second logic unit 16. A power terminal 3 of the Schmitt filter U2 is coupled to the second power terminal V2. A ground terminal 4 of the Schmitt filter U2 is grounded.

An output terminal 3 of the second logic unit 16 is coupled to a signal input pin 1 of the third control module 13. A power terminal of the second logic unit 16 is coupled to the second power terminal V2. A ground terminal 5 of the second logic unit 16 is grounded.

A ground pin 3 of the third control module 13 is grounded. A first power pin 4 of the third control module 13 is coupled to the second power terminal V2. A second power pin 5 of the third control module 13 is coupled to the second power terminal V2. Both of the first power pin 4 and the second power pin 5 of the third control module 13 are grounded through a resistor R6. A signal output pin 6 of the third control module 13 is coupled to the alarm module 14.

The alarm module 14 can comprise a light-emitting diode (LED) D1 and a resistor R7. An anode of the LED D1 is coupled to the second power terminal V2 through the resistor R7. A cathode of the LED D1 is coupled to the signal output pin 6 of the third control module 13.

In the embodiment, the indicating circuit 100 is used in a server 200. The first power terminal V1 supplies a first voltage when the server 200 is operating. The second power terminal V2 supplies an auxiliary voltage when the server 200 is coupled to AC.

When the server 200 is not operating and coupled to AC, the second power terminal V2 supplies the auxiliary voltage. The first logic unit 15 outputs a high level signal. The second logic unit 16 outputs a high level signal. The enable pin 2 of the third control module 13 is at a high level. The signal input pin 1 of the third control module 13 is at a high level. The third control module 13 outputs a high level signal through the signal output pin 6. The LED D1 is not lit up.

In the embodiment, a resistance of the resistor R4 is much greater than a resistance of the resistor R5. A first delay circuit is composed by the resistor R4 and the capacitor C2. A second delay circuit is composed by the resistor R5 and the capacitor C3. The first delay circuit can cause a first delay in the indicating circuit 100. The second delay circuit can cause a second delay in the indicating circuit 100. The first delay is greater than the second delay. When the input terminal 1 of the Schmitt filter U2 turns into a low level, the input terminal 1 of the Schmitt filter U1 is still at a high level. The enable pin 2 of the third control module 13 is still at a high level. The third control module 13 outputs a high level signal. The LED D1 is not lit up.

When the server 200 is operating and a temperature of the server 200 is not higher than a preset value, the first control module 11 outputs a high level signal through the signal output pin 1. The switch unit 19 outputs a high level signal through the signal output pin 5 to the first input terminal 1 of the first logic unit 15. The second input terminal 2 of the logic unit 15 is at a low level. The first logic unit 15 outputs a high level signal to the enable pin 2 of the third control module 13. The signal input pin 1 of the second control module 12 receives the high level signal from the first control module 11. The second control module 12 outputs a high level signal through the signal output pin 2. The first input terminal 1 of the second logic unit 16 is at a high level. The second logic unit 16 outputs a high level signal to the signal input pin 1 of the third control module 13. The third control module 13 outputs a high level signal through the signal output pin 6. The LED D1 is not lit up.

When the server 200 is operating and the temperature of the server is higher than the preset value, the first control module 11 outputs a low level signal through the signal output pin 1. The switch unit 19 outputs a low level signal through the signal output pin 5 to the first input terminal 1 of the first logic unit 15. The second input terminal 2 of the logic unit 15 is at a low level. The first logic unit 15 outputs a low level signal to the enable pin 2 of the third control module 13. The signal input pin 1 of the second control module 12 receives the low level signal from the first control module 11. The second control module 12 outputs a low level signal through the second output pin 2. The first input terminal 1 of second logic unit 16 and the second input terminal 2 of second logic unit 16 are at low levels. The second logic unit 16 outputs a low level signal through the signal output pin 6. The LED D1 is lit up.

In the embodiment, the first control module 11 is a central processing unit. The second control module 12 is a complex programmable logic unit. The third control module 13 is a latch. The first logic unit 15 is an OR gate. The second logic unit 16 is an OR gate.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An indicating circuit of an electronic device, the indicating circuit comprising:
a first control module;
a second control module;
a third control module; and
an alarm module;
wherein an output terminal of the first control module is coupled to a first input terminal of the third control module, an output terminal of the second control module is coupled to a second input terminal of the third control module, and an output terminal of the third control module is coupled to the alarm module;
wherein the modules are configured such that when the electronic device is operating and the temperature of the electronic device does not exceed a preset value, the first control module outputs a first control signal to the third control module, the second control module outputs the first control signal to the third control module, the third control module outputs the first control signal to the alarm module, and the alarm module indicates that the temperature of the electronic device does not exceed the preset value; and
wherein the modules are further configured such that when the electronic device is operating and the temperature of the electronic device exceeds the preset value, the first control module outputs a second control signal to the third control module, the second control module outputs the second control signal to the third control module, the third control module outputs the second control signal to the alarm module, and the alarm module indicates that the temperature of the electronic device exceeds the preset value.

2. The indicating circuit as claim 1, further comprising a first logic unit, a second logic unit, a first delay module, and a second delay module, wherein the first delay module is configured to couple the first logic unit, the second delay module is configured to couple the second logic unit, the first control module is configured to couple the third control module through the first logic unit, the second control module is configured to couple the third control module through the second logic unit.

3. The indicating circuit as claim 2, wherein the first control signal is a high level signal, the second control signal is a low level signal.

4. The indicating circuit as claim 2, wherein the first delay module comprises a first delay circuit, the second delay module comprises a second delay circuit, when the electronic device is coupled to AC, the first delay circuit and the second delay circuit start to operate, the first delay circuit can cause a first delay, the second delay circuit can cause a second delay, the first delay is greater than the second delay.

5. The indicating circuit as claim 4, wherein the first delay circuit comprises a first capacitor and a first resistor, the first delay module is coupled to a power terminal, the power terminal is grounded through the first capacitor and the first resistor in that order.

6. The indicating circuit as claim 5, wherein the second delay module further comprises a second Schmitt filter, an input terminal of the second Schmitt filter is coupled to a node between the second capacitor and the second resistor, an output terminal of the second Schmitt filter is coupled to the second logic unit.

7. The indicating circuit as claim 2, wherein the first logic unit is an OR gate.

8. The indicating circuit as claim 2, wherein the second logic unit is an OR gate.

9. The indicating circuit as claim 2, wherein the third control module is a latch.

10. The indicating circuit as claim 9, wherein when the electronic device is coupled to AC, the power terminal starts to supply a first voltage.

11. The indicating circuit as claim 9, wherein the second delay circuit comprises a second capacitor and a second resistor, the power terminal is grounded through the second capacitor and the second resistor in that order.

12. The indicating circuit as claim 9, where in the first delay module further comprises a first Schmitt filter, an input terminal of the first Schmitt filter is coupled to a node between the first capacitor and the first resistor, an output terminal of the first Schmitt filter is coupled to the first logic unit.

13. The indicating circuit as claim 2, wherein the alarm module comprises a light-emitting diode.
